(19) United States
(12) Patent Application Publication
(10) Pub. No.: US 2004/0100242 A1
(43) Pub. Date: May 27, 2004

(54) Voltage generation circuit

(76) Inventor: Youichi Tobita, Chiyoda-ku (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/473,356

(22) PCT Filed: Feb. 22, 2002
(86) PCT No.: PCT/JP02/01590

(51) Int. Cl. G05F 3/16

(52) U.S. Cl. 323/314

(57) ABSTRACT

A voltage generation circuit in which an alternating voltage is inputted through an input node and a constant voltage is outputted through an output node, wherein charge transfer means, which is provided between the input node and the output node, is so controlled by the alternating voltage of the input node that an amount of electric charge flowing from the input node to the output node is different from an amount of electric charge flowing from the output node to the input node. That is, movement of electric charge from the input node to the output node is allowed, while backflow of electric charge from the output node to the input node is prevented. The circuit includes a first input node to which an alternating voltage is inputted; a second input node to which a constant reference voltage is inputted; a first switching element which is connected between the first input node and an output node; a second switching element which is connected between the second input node and a control terminal of the first switching element; and a third switching element which is connected between the control terminal of the first switching element and the output node. The control terminals of the second and third switching elements are connected to the first input node.

### TECHNICAL FIELD

The present invention relates to a voltage generation circuit using insulated-gate field-effect transistors, and more specifically, to a voltage generation circuit which generates a voltage obtained by multiplying a power supply voltage and a voltage opposite in polarity to the power supply voltage.

### BACKGROUND ART

As a circuit for generating a higher voltage than the power supply voltage, the boosted potential generation circuit shown in FIG. 10 has been known. This circuit is used in the power supply for a circuit requiring a higher voltage than the power supply voltage, such as a word line driving circuit in a memory device like a DRAM or a flash memory.

In FIG. 10, numeral 1 denotes a terminal which is supplied with power V_{DD} having a voltage value V_{DD}, and numerals 2 and 3 denote terminals to which repetitive signals Φ and /Φ (/Φ is a phase inversed signal of the signal Φ) opposite in phase to each other are inputted. In this case, the power V_{DD} can be either generated in an internal circuit of the memory device or supplied from outside. Similarly, the signals Φ and /Φ can be either generated in an internal circuit of the memory device or supplied from outside.

Numeral 4 denotes an N-type field-effect transistor which is connected between the power supply terminal 1 and a node 6, and a gate electrode of which is connected to a node 7. Numeral 5 denotes an N-type field-effect transistor which is connected between the power supply terminal 1 and the node 7, and a gate electrode of which is connected to the node 6. Numeral 8 denotes a boosting capacitor connected between the node 6 and the input terminal 2, and numeral 9 denotes a boosting capacitor connected between the node 7 and the input terminal 3.

Numeral 10 denotes a parasitic capacitor appearing between the node 6 and the ground, and numeral 12 denotes a node to which the output voltage Vₚₚ of the boosted potential generation circuit is outputted. Numeral 11 denotes a P-type field-effect transistor in which the drain electrode and the gate electrode are short-circuited or diode-connected, and which is disposed between the node 6 and the node 12. Numeral 13 denotes a capacitor for stabilizing an output voltage, and one terminal thereof is connected to the output node 12 and the other terminal to the ground terminal. The other terminal of the capacitor 13 has only to have the constant potential and is not necessarily at the ground potential.

The operations of the boosted potential generation circuit will be described with reference to FIG. 11. By supplying the repetitive signals Φ and /Φ, which have an amplitude V_{Φ} and are opposite in phase to each other, several number of times, the potential of the node 7 rises gradually. If the repetitive signal /Φ rises to make the voltage of the node 7 or the gate voltage of the transistor 4 higher than the sum (V_{DD}+V_{TN}) of the power supply voltage V_{DD} and the threshold voltage V_{TN} of the transistor 4, then the transistor 4 is brought into conduction. Via the transistor 4 in conduction, the node 6 is charged to a level of V_{DD} by the power supply voltage V_{DD} of the terminal 1. Then, the signal /Φ falls to make the node 7 a level of V_{DD}, bringing the transistor 4 out of conduction. Therefore, when the repetitive signal Φ rises, the node 6 is multiplied to the following voltage V₆ by the signal Φ.

V₆=V_{DD}+V_{Φ}·C₈/(C₈+C₁₀) (1)

Here, C₈ is a capacitance value of the boosting capacitor 8, and C₁₀ a capacitance value of the parasitic capacitor 10. The capacitance value C₈ is generally set far larger than the capacitance value C₁₀, that is, C₈,C₁₀, so the equation (1) becomes as follows.

V₆≈V_{DD}+V_{Φ} (2)

Therefore, as shown in FIG. 11, the node 6 outputs a signal having an amplitude V_{Φ} (signal in which the rectangular wave of the amplitude V_{Φ} is added to V_{DD}), with a level of V_{DD} as the reference. Thus, the circuit composed of the field-effect transistors 4, 5 and the boosting capacitors 8, 9 operates to convert the reference level of the repetitive signal Φ from 0 to V_{DD}.

The electric charge charged in the node 6 is transferred to the node 12 via the transistor 11, thereby increasing the level of the node 12 and decreasing the potential of the node 6.

After repeating these operations, the level V₁₂ of the node 12, that is, the output voltage Vₚₚ of the boosted potential generation circuit ultimately becomes as follows.

V₁₂=Vₚₚ=V_{DD}+V_{Φ}−|V_{TP}| (3)

Here, V_{TP} is a threshold voltage of the transistor 11. The circuit for generating the repetitive signals Φ and/are generally operated by the same power supply, that is, the power supply V_{DD}, so that the amplitude V_{Φ} of the repetitive signals Φ and/Φ also has the power supply voltage V_{DD}. In this case, the equation (3) becomes as follows.

Vₚₚ=2V_{DD}−|V_{TP}| (4)

The equation (4) indicates that when the power supply voltage V_{DD} is comparatively high, the output voltage Vₚₚ is not affected very much by the second term or the threshold voltage V_{Tp} of the transistor. On the other hand, when the power supply voltage V_{DD} is comparatively low, the output voltage Vₚₚ is greatly affected by the threshold voltage of the transistor.

With finer processing of memory devises in recent years, it has been tried to lower the power supply voltage. Since it is difficult to lower the threshold voltage of the transistor in proportion to a decrease in the power supply voltage, the second term in the equation (4) has larger influence. In other words, the output voltage Vₚₚ is greatly affected by the threshold voltage of the transistor. In result, when the threshold voltage is fluctuated by a change in manufacturing conditions, it becomes impossible to obtain a sufficient output voltage, which leads to a decrease in the operation margin of the memory device.

In recent years it has been increasing to use low-temperature polysilicon TFTs as switching elements in a liquid crystal display device and the like. In this case, it is preferable to use low-temperature polysilicon TFTs as the filed-effect transistors of the boosted potential generation circuit and to form them at the same time as the switching elements. However, low-temperature polysilicon TFTs, which exhibit a wide range of variation in threshold voltage and are poor in sub threshold properties, must have a large threshold voltage. Therefore, the ratio between the threshold voltage and the power supply voltage becomes larger than in the case of a memory device, thereby making the second term in the equation (4) more influential.

### DISCLOSURE OF INVENTION

The present invention, which has been contrived to solve the aforementioned problems, realizes a voltage generation circuit in which the output voltage is not affected by the threshold voltages of field-effect transistors, thereby preventing the occurrence of fluctuations in the output voltage, even when the threshold voltages of the field-effect transistors are varied by a change in manufacturing conditions and the like.

The voltage generation circuit of the present invention is a voltage generation circuit in which an alternating voltage is inputted through an input node and a constant voltage is outputted through an output node, characterized in that charge transfer means, which is provided between the input node and the output node, is so controlled by the alternating voltage of the input node that an amount of electric charge flowing from the input node to the output node is different from an amount of electric charge flowing from the output node to the input node, to form a rectifier which causes no voltage drop in the forward direction. In other words, this structure allows electric charge to transfer from the input node to the output node and prevents its backflow from the output node to the input node. Alternatively, the structure allows negative charge to transfer from the input node to the output node and prevents its backflow from the output node to the input node. Consequently, the peak value of the alternating voltage of the input node becomes the voltage of the output node.

To be more specific, the voltage generation circuit of the present invention comprises: a first input node to which an alternating voltage is inputted; a second input node to which a constant reference voltage is inputted; a first switching element which is connected between the first input node and an output node; a second switching element which is connected between the second input node and a control terminal of the first switching element; and a third switching element which is connected between the control terminal of the first switching element and the output node. The control terminals of the second and third switching elements are connected to the first input node.

Another voltage generation circuit of the present invention is a voltage generation circuit in which a constant voltage and an alternating voltage signal is supplied to an input terminal, and a constant voltage is outputted through an output terminal, comprising: voltage level conversion means for converting the reference level of the alternating voltage signal and outputting a converted reference level to an intermediate node; and charge transfer means which is provided between the intermediate node and the output terminal, and which is so controlled by the voltage signal of the intermediate node that an amount of electric charge flowing from the intermediate node to the output terminal is different from an amount of electric charge flowing from the output terminal to the intermediate node to form a rectifier which causes no voltage drop in the forward direction.

As described earlier, the charge transfer means might comprise, for example, a first switching element which is connected between the intermediate node and the output terminal; a second switching element which is connected between the input terminal having a constant voltage and the control terminal of the first switching element; and a third switching element which is connected between the control terminal of the first switching element and the output terminal. The control terminals of the second and third switching elements are connected to the intermediate node.

The voltage level conversion means might comprise, for example, a fourth switching element disposed between the input terminal having a constant voltage and the intermediate node; a first capacitor disposed between the intermediate node and the input terminal of the alternating voltage signal; and reverse phase signal supply means which supplies the control terminal of the fourth switching element with a signal having a reverse phase against the alternating voltage signal.

The reverse phase signal supply means might comprise, for example, a reverse phase signal input terminal which is supplied with an alternating signal having a reverse phase against the alternating voltage signal; a second capacitor which is disposed between the reverse phase signal input terminal and the control terminal of the fourth switching element; and a fifth switching element which is disposed between the input terminal having the constant voltage and the control terminal of the fourth switching element, and which is controlled by the voltage signal of the intermediate node.

In the voltage generation circuit including such a charge transfer means and a voltage level conversion means, the voltage level conversion means converts the level of the inputted alternating voltage signal and outputs it to the intermediate node. For example, when a positive voltage is supplied to the input terminal as a constant voltage, the voltage level conversion means adds the positive voltage to the alternating voltage signal and outputs it to the intermediate node. Accordingly, in the case where a constant voltage V_{DD} and an alternating voltage changing between 0 and V_{DD} are supplied, the intermediate node is supplied with an alternating voltage changing between V_{DD} and 2V_{DD}. As described earlier, the charge transfer means outputs the peak value of the alternating voltage of the intermediate node as the voltage of the output terminal. Accordingly, the voltage generation circuit outputs a constant voltage 2V_{DD}.

On the other hand, in the case where the input terminal is grounded, that is, the ground potential is supplied as the constant voltage, the peak value of the alternating voltage signal appearing in the intermediate node becomes the ground potential. Therefore, when an alternating voltage changing between 0 and V_{DD} is supplied, an alternating voltage changing between −V_{DD} and 0 potential is generated in the intermediate node. As described earlier, the charge transfer means outputs the peak value of the alternating voltage of the intermediate node as the voltage of the output terminal. Consequently, the voltage generation circuit outputs a constant voltage −V_{DD}.

As the switching elements, field-effect transistors is preferably used, and when a positive voltage is outputted, that is, a positive voltage is supplied as a constant voltage, the first switching element is a P-type field-effect transistor, the second switching element is an N-type field-effect transistor, and the third switching element is a P-type field-effect transistor. The fourth and fifth switching elements are N-type field-effect transistors.

On the other hand, when a negative voltage is outputted, that is, the ground voltage is supplied as a constant voltage, the first switching element is an N-type field-effect transistor, the second switching element is a P-type field-effect transistor, and the third switching element is an N-type field-effect transistor. The fourth and fifth switching elements are P-type field-effect transistors.

It is possible to connect the control terminal of the first switching element of the charge transfer means and the reverse phase signal input terminal via a third capacitor. This quickens the operation of the first switching element, making it possible to prevent backflow of electric charge (or negative charge) more securely.

The output terminal (or output node) of the voltage generation circuit can be provided with a voltage stabilization capacitor. The other end of the voltage stabilization capacitor is connected to the voltage source having a constant voltage, which can be a ground potential or another potential.

A further another voltage generation circuit of the present invention is formed by connecting charge transfer means in series in plural stages in the aforementioned voltage generation circuit. The output of the charge transfer means in the preceding stage and a voltage signal obtained by combining this output and the alternating voltage signal are supplied to the charge transfer means in the next stage, which outputs a voltage higher (or lower) than the charge transfer means in the preceding stage by the peak-to-peak voltage amplitude of the alternating voltage signal. Therefore, a higher voltage can be outputted by increasing the number of stages of the charge transfer means.

To be more specific, the charge transfer means comprises: an input node to which an alternating voltage signal is inputted; an input terminal to which a reference voltage is inputted; a first and a second output node which output a constant voltage; a first switching element which is connected between the input node and the first output node; an additional switching element which is connected between the input node and the second output node; a connection node to which the control terminal of the first switching element and the control terminal of the additional switching element are connected; a second switching element which is connected between the reference voltage input terminal and the connection node; and a third switching element which is connected between the connection node and the first output node.

The first switching element and the additional switching element operate in the same manner, and the same voltage is outputted to the first and second output nodes. The output of the second output node is used as it is as the reference voltage in the next stage, and an alternating voltage signal is added to the first output node and is supplied to the input node in the next stage.

In this voltage detection circuit, it is possible to take out not only the output having a constant voltage from the charge transfer means in the final stage but also the intermediate voltage having a constant voltage from the second output node of the charge transfer means in the intermediate stage. In this case, it is necessary to see that the voltage of the second output node does not fluctuate and affect the operation of the switching elements in the next stage. It is possible to connect another additional switching element in the same manner as the first switching element and the additional switching element so as to take out an intermediate voltage.

### BRIEF DESCRIPTION OF DRAWINGS

FIG. 1 shows a voltage generation circuit according to one embodiment of the present invention;

FIG. 2 shows a voltage generation circuit according to another embodiment of the present invention;

FIG. 3 shows a voltage generation circuit according to further embodiment of the present invention;

FIG. 4 is a view to explain the operations of the voltage generation circuit shown in FIG. 3;

FIG. 5 shows a voltage generation circuit according to still further embodiment of the present invention;

FIG. 6 shows a voltage generation circuit according to yet further embodiment of the present invention;

FIG. 7 shows a voltage generation circuit according to another embodiment of the present invention;

FIG. 8 shows a voltage generation circuit according to further another embodiment of the present invention;

FIG. 9 shows a voltage generation circuit according to still further embodiment of the present invention;

FIG. 10 shows a conventional voltage generation circuit; and

FIG. 11 is a view to explain the operations of the conventional voltage generation circuit shown in FIG. 10.

### BEST MODE FOR CARRYING OUT THE INVENTION

The embodiments according to the present invention will be described as follows with reference to the drawings. Note that in the following embodiments a power supply voltage V_{DD} and an amplitude V_{Φ} of repetitive signals Φ and /Φ are equal to each other (V_{Φ}=V_{DD}) for convenience of explanation; however, it is not always necessary that V_{Φ} and V_{DD} are equal to each other.

### Embodiment 1

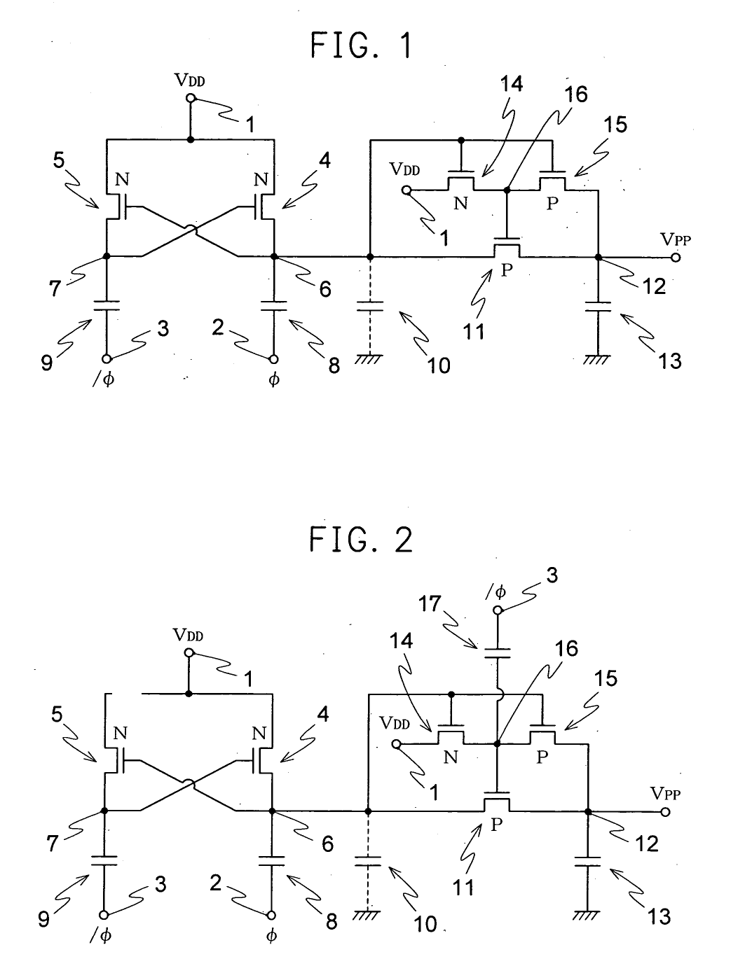

FIG. 1 shows the voltage generation circuit according to one embodiment of the present invention.

In FIG. 1, numeral 1 denotes a terminal which is supplied with power V_{DD} having a voltage value V_{DD}, and numerals 2 and 3 denote terminals to which repetitive signals Φ and /Φ (/Φ is a phase-inversed signal of the signal Φ) opposite in phase to each other are inputted.

Numeral 4 denotes an N-type field-effect transistor which is connected between the power supply terminal 1 and a node 6, and a gate electrode thereof is connected to a node 7. Numeral 5 denotes an N-type field-effect transistor which is connected between the power supply terminal 1 and the node 7, and a gate electrode thereof is connected to the node 6. Numeral 8 denotes a boosting capacitor connected between the node 6 and the input terminal 2, and numeral 9 denotes a boosting capacitor connected between the node 7 and the input terminal 3.

Numeral 10 denotes a parasitic capacitor appearing between the node 6 and the ground, and numeral 12 denotes a node to which an output voltage Vₚₚ of the boosted potential generation circuit is outputted. Numeral 13 is a capacitor for stabilizing the output voltage, and one terminal thereof is connected to the output node 12 and the other terminal to a ground terminal. The other terminal of the capacitor 13 has only to have the constant potential and is not necessarily at the ground potential.

Furthermore, in FIG. 1, numeral 11 denotes a P-type field-effect transistor disposed between the node 6 and the node 12. Numeral 14 denotes an N-type field-effect transistor disposed between the power supply terminal 1 and the node 16, and numeral 15 denotes a P-type field-effect transistor disposed between the output node 12 and a node 16. The gate electrode of the transistor 11 is connected to the node 16, and the gate electrodes of the transistors 14, 15 are connected to the node 6.

The circuit shown in FIG. 1 operates as follows.

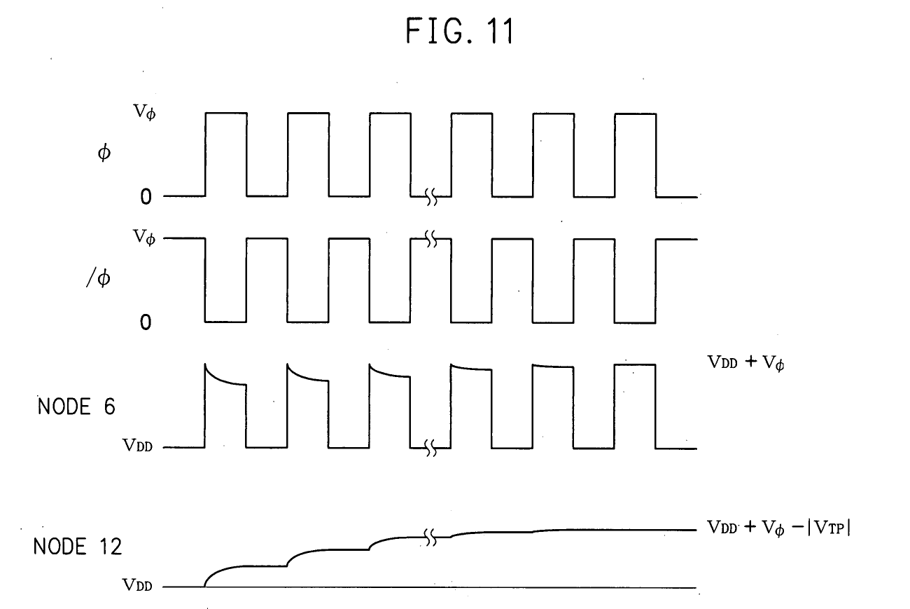

As already described with reference to FIG. 11, the potential of the node 6 changes between a level of V_{DD} and a level of 2V_{DD}. If the node 6 rises from the level of V_{DD} to the level of 2V_{DD}, the transistor 15 is brought out of conduction and the transistor 14 is brought into conduction, thereby applying the voltage V_{DD} of the terminal 1 to the gate electrode of the transistor 11. Since the source electrode of the transistor 11, that is, the node 6 has a voltage level of 2V_{DD}, the transistor 11 is brought into conduction. Consequently, there is a transfer of charge from the node 6 to the node 12, thereby raising the level of the node 12.

Then, when the node 6 falls from a level of 2V_{DD} to a level of V_{DD}, the transistor 14 is brought out of conduction because its source electrode or the terminal 1 has a voltage level of V_{DD} (the transistor 14 is brought out of conduction because the potential difference between the gate electrode and the source electrode, that is, between the node 6 and the terminal 1 is smaller than the threshold voltage V_{TN} of the transistor 14).

When the node 12 has not reached a level of V_{DD}+|V_{TP}|, both the transistors 15 and 11 are out of conduction, and there is no transfer of charge from the node 12 to the node 6 (these transistors are out of conduction because their gate electrodes, that is, the nodes 6 and 16 have a potential of V_{DD}, and the potential difference with the source electrode or the node 12 is smaller than the threshold voltage |V_{TP}|).

On the other hand, when the node 12 is at a level higher than V_{DD}+|V_{TP}|, the transistor 15 is brought into conduction. This makes the drain electrode (node 12) and gate electrode (node 16) of the transistor 11 have the same potential, bringing the transistor 11 out of conduction. In result, there is no transfer of charge from the node 12 to the node 6.

As described hereinbefore, when the potential of the node 6 rises to a level of 2V_{DD}, the transistor 14 brings the transistor 11 into conduction so as to transfer the charge of the node 6 to the node 12, thereby increasing the potential of the node 12. On the other hand, when the potential of the node 6 falls to a level of V_{DD}, the transistor 15 brings the transistor 11 out of conduction so as to prevent the transfer of charge from the node 12 to the node 6. Therefore, repeating these operations increases the voltage of the node 12 until it finally reaches a level of 2V_{DD}.

As described above, according to the present embodiment, the node 12 can have as the output voltage V_{PP} a voltage of 2V_{DD} which is not affected by the threshold voltages of the transistors (no voltage drop in the forward direction). Consequently, even if threshold values of the transistors have a wide range of variation due to a change in manufacturing conditions, the output voltage V_{PP} is not affected at all. Therefore, in the case where the voltage generation circuit of the present embodiment is used in a memory device or a liquid crystal display device, it becomes possible to secure the supply of a voltage having a constant margin as the voltage necessary for the operations of the transistors for data writing, thereby enhancing operation reliability of the device.

In the above description, the source electrode of the transistor 14 is connected to the terminal 1 or a level of V_{DD}; however, the voltage can be other than V_{DD} as long as the transistor 11 is brought into conduction when the level of the node 6 rises and is brought out of conduction when the level of the node 6 falls. In short, the source electrode of the transistor 14 has only to be at a level higher than V_{DD}−|V_{TP}| so as to bring the transistor 11 out of conduction when the node 6 falls to a level of V_{DD}, and lower than 2V_{DD}−|V_{TP}|(and 2V_{DD}−V_{TN}) so as to bring the transistor 11 into conduction when the level of the node 6 rises to a level of 2V_{DD}.

### Embodiment 2

FIG. 2 shows the voltage generation circuit according to another embodiment of the present invention. Regarding FIG. 2, the same components as those in the circuit shown in FIG. 1 are referred to with the same reference numerals and their description will be omitted.

In the voltage generation circuit of the present embodiment shown in FIG. 2, the node 16 and the input terminal 3 of the repetitive signal /Φ are connected with each other via a coupling capacitor 17.

The circuit shown in FIG. 2 operates as follows.

As described already, in Embodiment 1 when the node 6 falls from a level of 2V_{DD} to a level of V_{DD}, the transistor 15 is brought into conduction so as to make the gate electrode of the transistor 11 have the same potential as the node 12 (that is, the gate electrode and the drain electrode have the same potential). This brings the transistor 11 out of conduction, thereby preventing backflow of charge from the node 12 to the node 6.

However, it takes a certain time to bring the transistor 15 into conduction and to make the gate electrode of the transistor 11 the same potential as the node 12. During this time period, there might be backflow of charge from the node 12 to the node 6 side via the transistor 11.

To cope with this situation, in the present embodiment, a signal changing in a reverse phase against the node 6 is inputted to the node 16. Since the level of the node 6 changes in the same phase as the signal Φ as already described with reference to FIG. 11, as the reverse phase signal against this, the signal /Φ is inputted to the node 16. The signal /Φ rises according to the falling of the signal Φ, that is, the changing of the node 6 from a level of 2V_{DD} to a level of V_{DD} so as to raise the level of the node 16, thereby promoting a voltage rise in the gate electrode of the transistor 11. This brings the transistor 11 out of conduction faster, making it possible to secure the prevention of backflow of charge.

Although phases of the repetitive signals Φ and /Φ are substantially opposite to each other, it is preferable for the boosting operation of the boosted potential generation circuit that a high potential (H) period is shorter than a low potential (L) period and that the H period is included in the L period. On the other hand, in the present embodiment, it is preferable for the promotion of the potential rise in the node 16 by the coupling capacitor 17 that the potential rise in the signal /Φ is not delayed with regard to the potential drop in the signal Φ.

### Embodiment 3

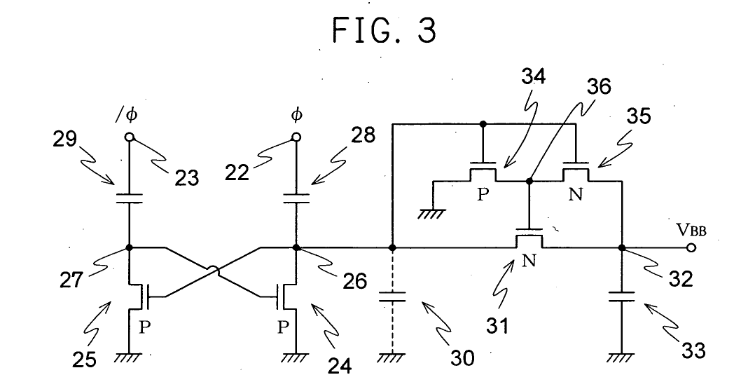

FIG. 3 shows the voltage generation circuit according to further embodiment of the present invention. The voltage generation circuit shown in FIG. 3 is a charge pump circuit which generates a voltage opposite in polarity to the power supply voltage. The voltage opposite in polarity to the power supply voltage can be used in power supplies for a substrate bias of a DRAM, for a word line driving circuit of a flash memory, and for a gate line driving circuit of a liquid crystal display device using low-temperature polysilicon TFTs.

In FIG. 3, numerals 22 and 23 denote terminals to which repetitive signals Φ and /Φ opposite in phase to each other are inputted. Numeral 24 denotes a P-type field-effect transistor which is disposed between the reference potential (the ground potential in this case) and a node 26, and a gate electrode thereof is connected with a node 27. Numeral 25 denotes a P-type field-effect transistor which is disposed between the reference potential (the ground potential) and the node 27, and a gate electrode thereof is connected with the node 26. Numeral 28 denotes a charge pump capacitor connected between the node 26 and the terminal 22, and numeral 29 denotes a voltage dropping capacitor connected between the node 27 and the terminal 23.

Numeral 30 denotes a parasitic capacitor disposed between the node 26 and the ground, and numeral 32 is a node to which a negative voltage V_{BB} which is the output of the voltage generation circuit is outputted. Numeral 31 denotes an N-type field-effect transistor disposed between the node 26 and the node 32. Numeral 33 denotes a capacitor for stabilizing the output voltage and is disposed between the output node 32 and the ground.

Numeral 34 denotes a P-type field-effect transistor disposed between the ground and a node 36, numeral 35 denotes an N-type field-effect transistor disposed between the output node 32 and the node 36, and the node 36 is connected with the gate electrode of the transistor 31. The gate electrodes of the transistors 34 and 35 are connected with the node 26.

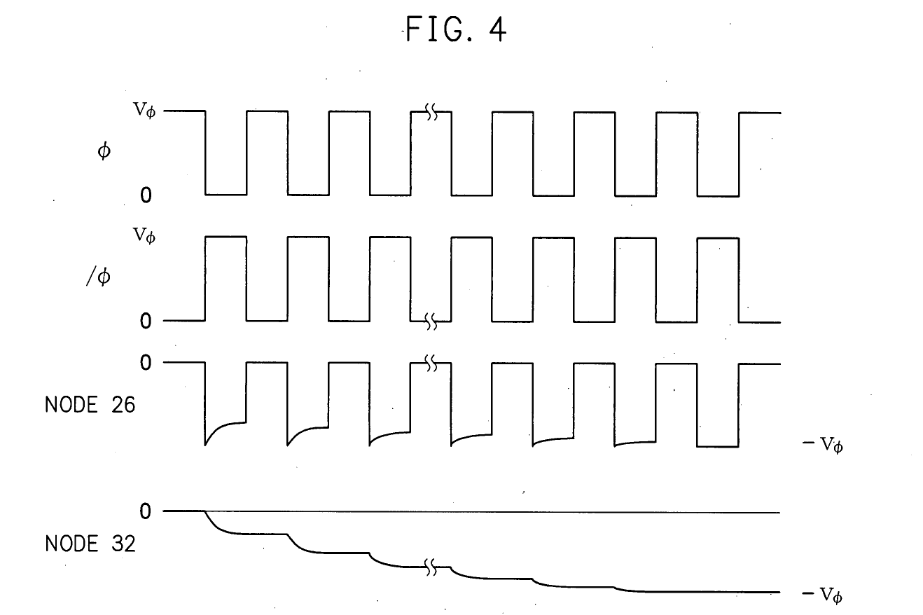

The operations of the voltage generation circuit shown in FIG. 3 will be described as follows with reference to FIG. 4.

By supplying the repetitive signals Φ and /Φ, which have an amplitude of V_{DD} and nearly reverse phases, several number of times, the potential of the node 27 falls gradually. At this moment, if the repetitive signal /Φ falls and the gate voltage of the transistor 24 gets lower than the threshold value of the transistor 24 with regard to the ground level, the transistor 24 is brought into conduction, making the node 26 be discharged to the ground level via the transistor 24. If the signal Φ falls after the signal /Φ rises to put the node 27 a level of V_{DD} and to bring the transistor 24 out of conduction, the signal Φ makes the node 26 fall to the following voltage V₂₆:

V₂₆=−V_{DD}·C₂₈/(C₂₈+C₃₀) (5)

Here, C₂₈ is the capacitance value of the charge pump capacitor 28, and C₃₀ is a capacitance of the parasitic capacitor 30. The capacitance value C₂₈ is generally set far larger than the capacitance value C₃₀, that is, C₂₈,C₃₀, so the equation (5) becomes as follows.

V₂₆≈−V_{DD} (6)

Therefore, as shown in FIG. 4, the potential of the node 26 changes between the ground level and a level of −V_{DD}. If the potential of the node 26 falls from the ground level to a level of −V_{DD}, the transistor 35 is brought out of conduction and the transistor 34 is brought into conduction, thereby making the gate voltage of the transistor 31 the ground potential. Since the source electrode of the transistor 31 (that is, the node 26) has a voltage level of −V_{DD}, the transistor 31 is brought into conduction, and there is a transfer of negative charge from the node 26 to the node 32, thereby decreasing the voltage level of the node 32.

When the node 26 rises from a level of −V_{DD} to the ground level, the transistor 34 is brought out of conduction because its source electrode is in the ground potential (the transistor 34 is brought out of conduction because the level of the gate electrode or the node 26 is higher than the threshold voltage V_{TP} (V_{TP} is a negative value) of the transistor 34).

When the level of the node 32 is higher than −V_{TN} (V_{TN} is a threshold value of the transistor 35), the transistor 35 is out of conduction, and the gate electrode of the transistor 31 remains in the ground potential. Accordingly, the transistor 31 is out of conduction, and there is no transfer of negative charge from the node 32 to the node 26.

On the other hand, when the level of the node 32 is lower than −V_{TN}, the transistor 35 is brought into conduction, thereby making the drain electrode (node 32) and gate electrode (node 36) of the transistor 31 have the same potential. Accordingly, the transistor 31 is still out of conduction, and there is no transfer of negative charge from the node 32 to the node 26.

As described hereinbefore, when the potential of the node 26 falls to a level of −V_{DD}, the transistor 34 brings the transistor 31 into conduction so as to transfer the negative charge of the node 26 to the node 32, thereby decreasing the potential of the node 32. On the other hand, when the potential of the node 26 becomes the ground level, the transistor 35 brings the transistor 31 out of conduction so as to prevent the transfer of negative charge from the node 32 to the node 26. Therefore, repeating these operations decreases the voltage of the node 32 until it finally reaches a level of −V_{DD}.

As described above, according to the present embodiment, the node 32 can have, as an output voltage V_{BB}, a voltage −V_{DD} which is not affected by the threshold voltages of the transistors. Therefore, even if threshold values of the transistors have a wide range of variation, the output voltage V_{BB} is not affected at all.

In the aforementioned description, the source electrode of the transistor 34 has the ground potential; however, the voltage can be other than the ground potential as long as the transistor 31 is brought into conduction when the level of the node 26 falls and is brought out of conduction when the level of the node 26 rises. In short, the source electrode of the transistor 34 has only to be at a level higher than −V_{DD}+V_{TN} so as to bring the transistor 31 into conduction when the node 6 reaches the level of −V_{DD}, and lower than V_{TN} so as to bring the transistor 11 out of conduction when the level of the node 6 rises to the ground potential.

### Embodiment 4

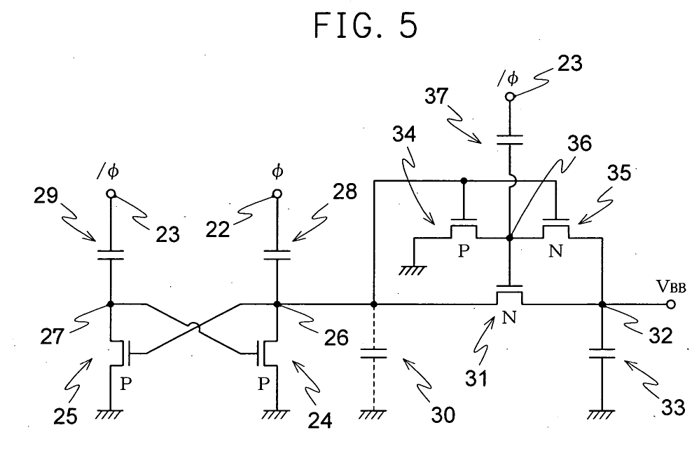

FIG. 5 shows a voltage generation circuit according to still further embodiment of the present invention. Regarding FIG. 5, the same components as those in the circuit shown in FIG. 3 are referred to with the same reference numerals and their description will be omitted.

In the voltage generation circuit of the present embodiment shown in FIG. 5, a node 36 and the input terminal 23 of a repetitive signal /Φ are connected with each other via a coupling capacitor 37.

The circuit shown in FIG. 5 operates as follows.

As described already, in Embodiment 3 when the node 36 rises from a level of −V_{DD} to the ground level, a transistor 35 is brought into conduction so as to make the gate electrode of the transistor 31 have the same potential as a node 32. This brings the transistor 31 out of conduction, thereby preventing backflow of negative charge from the node 32 to the node 26.

However, it takes a certain time to bring the transistor 35 into conduction and to make the gate electrode of the transistor 31 have the same potential as the node 32. During this time period, there might be backflow of negative charge from the node 32 to the node 26 side via the transistor 31.

To cope with this situation, in the present embodiment, a signal changing in a reverse phase against the node 26 is inputted to the node 36. Since the level of the node 26 changes in the same phase as the signal Φ as already described with reference to FIG. 4, as the reverse phase signal against this, the signal /Φ, for example, is inputted to the node 36. The signal /Φ falls according to the rising of the signal Φ, that is, the changing of the node 26 from a level of −V_{DD} to the ground level so as to drop the level of the node 36, thereby promoting a voltage drop in the gate electrode of the transistor 31. This brings the transistor 31 out of conduction faster, making it possible to secure the prevention of backflow of negative charge.

Although phases of the repetitive signals Φ and /Φ are substantially opposite to each other, it is preferable for the boosting operation of the boosted potential generation circuit that a low potential (L) period is shorter than a high potential (H) period and that the L period is included in the H period. On the other hand, in the present embodiment, it is preferable for the promotion of the potential drop in the node 36 by the coupling capacitor 37 that the potential drop in the signal /Φ is not delayed with regard to the potential rise in the signal Φ.

### Embodiment 5

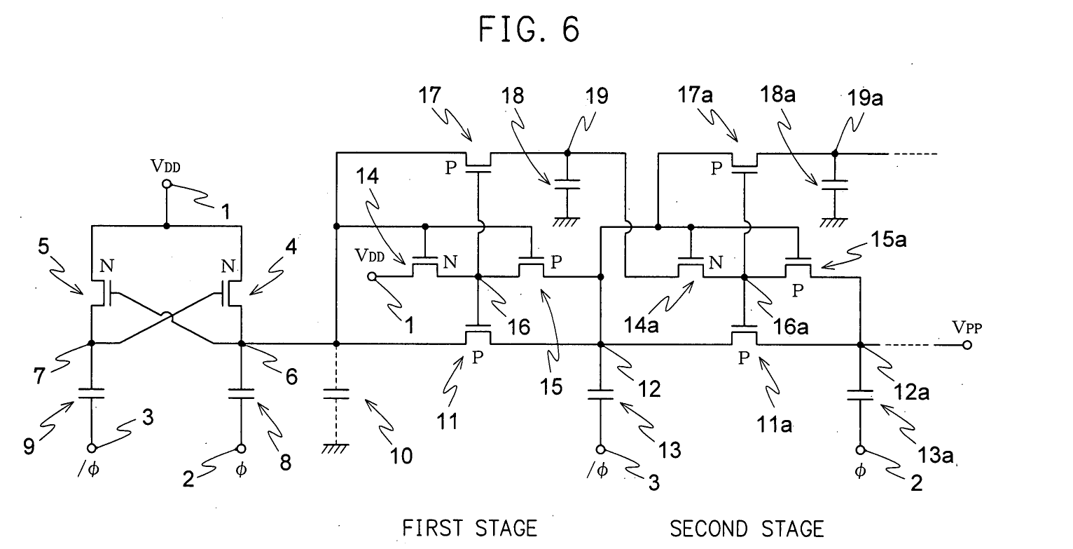

FIG. 6 shows the voltage generation circuit according to yet further embodiment of the present invention. The voltage generation circuit shown in FIG. 6 is a circuit for generating a positive voltage which is n times (n is an integer) the magnitude of the power supply voltage V_{DD}. Regarding FIG. 6, the same components as those in the circuit shown in FIG. 1 are referred to with the same reference numerals and their description will be omitted.

The voltage generation circuit of Embodiment 1 shown in FIG. 1 can be considered to include a boosting circuit which is composed of the transistors 4, 5 and the capacitors 8, 9 and which converts the reference level of the input signal Φ; and a charge transfer circuit which is composed of the transistors 11, 14, and 15 and which transfers charge from the node 6 to the node 12 so as to prevent backflow of charge from the node 12 to the node 6. In this voltage generation circuit of FIG. 1, it is possible to connect n charge transfer circuits in series to generate a positive voltage which is n times the magnitude of the voltage V_{DD}.

The voltage generation circuit of the present embodiment shown in FIG. 6 is formed by providing the voltage generation circuit shown in FIG. 1 with the charge transfer circuit in the second stage which is composed of transistors 11a, 14a, and 15a. Furthermore, the node 12 which is the output of the first stage is supplied with a repetitive signal /Φ (or Φ). In addition, the charge transfer circuit in the first stage is provided with a transistor 17 and a voltage stabilization capacitor 18. The transistor 17 and the capacitor 18 operate in the same manner as the transistor 11 and the capacitor 13 so as to generate a voltage 2V_{DD} in the node 19. Consequently, the voltage of the node 12 changes between a level of 2V_{DD} and a level of 3V_{DD} (=2V_{DD}+V_{Φ}), whereas the voltage of the node 19 is nearly constant at a level of 2V_{DD}.

As mentioned earlier, in the charge transfer circuit in the first stage, a voltage changing between a level of V_{DD} and a level of 2V_{DD} is supplied to the source electrode of the transistor 11 and to the gate electrodes of the transistors 14, 15, whereas the nearly constant voltage V_{DD} is supplied to the source electrode of the transistor 14. Further, the voltage 2V_{DD} is outputted to the node 12.

Similarly, it is possible to supply a voltage changing between a level of 2V_{DD} and a level of 3V_{DD} to the source electrode of the transistor 11a and to the gate electrodes of the transistors 14a, 15a and to supply the nearly constant voltage 2V_{DD} to the source electrode of the transistor 14a so as to obtain a voltage 3V_{DD} in the node 12a as the output of the charge transfer circuit in the second stage.

According to the present embodiment, in the voltage generation circuit of FIG. 1, charge transfer circuits can be connected in series in plural stages so as to input a voltage which is V_{DD} higher than each input of the charge transfer circuit in the previous stage to the charge transfer circuit in the following stage. This facilitates obtaining of an output voltage which is an integral multiple of the power supply voltage, such as 3V_{DD}, 4V_{DD}, - - - (n+1)V_{DD}.

### Embodiment 6

In the voltage generation circuit shown in FIG. 6, the node 12n in the final stage out of the nodes 12, 12a, - - - , 12n serves as the output; however, it is also possible to use the nodes 19, 19a, - - - as the output. For example, it is possible to take out a voltage 2V_{DD} from the node 19, and a voltage 3V_{DD} from the node 19a.

According to the present embodiment, it is possible to output an intermediate voltage besides the output voltage in the final stage. This can eliminate the need for the provision of plural voltage generation circuits, even when different voltages are necessary, which is advantageous in terms of cost, space, and reliability.

### Embodiment 7

In the voltage generation circuit of Embodiment 6 where the intermediate voltage is outputted from the nodes 19, 19a, - - - , there are such cases that a large amount of current flows to the load and decreases the output voltage, that is, the voltage of the nodes 19, 19a, - - - .

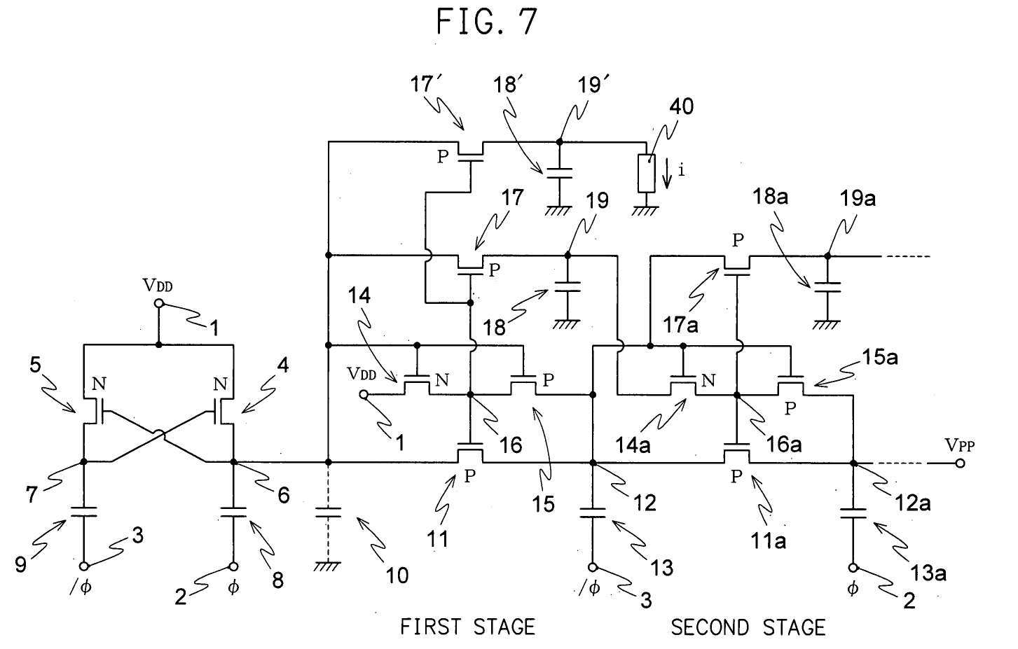

In such a case, as shown in FIG. 7, it is possible to provide a transistor 17′ and a voltage stabilization capacitor 18′ in parallel to the transistor 17 and the voltage stabilization capacitor 18, and to connect a load 40 to the node 19′.

Even when the output voltages of the nodes 19′, 19a′, - - - are decreased by the load current “i”, the output voltages of the nodes 19, 19a, - - - are hardly affected. This can secure the operation of the voltage transfer circuit (transistors 11a, 11b, - - - ), without a fluctuation in the voltages to be supplied to the transistors 14a, 14b, - - - in the next stage.

### Embodiment 8

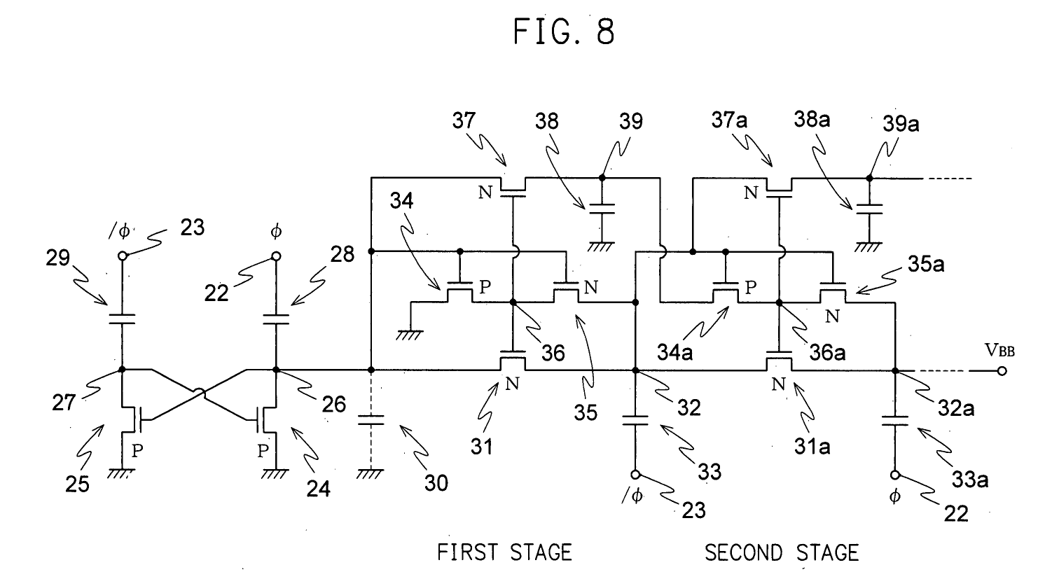

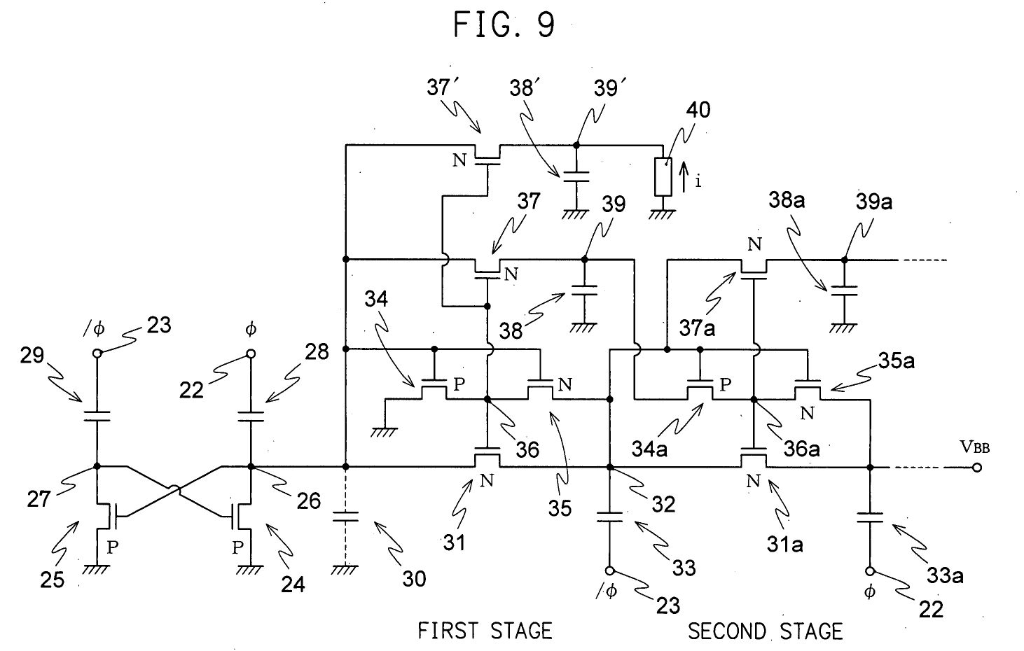

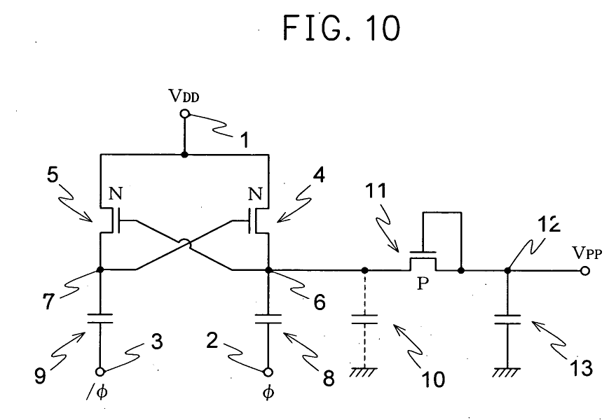

FIG. 8 shows the voltage generation circuit according to further another embodiment of the present invention. The voltage generation circuit shown in FIG. 8 is a circuit for generating a negative voltage which is n times (n is an integer) the magnitude of the power supply voltage V_{DD}. Regarding FIG. 8, the same components as those in the circuit shown in FIG. 3 are referred to with the same reference numerals and their description will be omitted.

The voltage generation circuit of Embodiment 3 shown in FIG. 3 can be considered to include of a circuit which is composed of the transistors 24, 25 and the capacitors 28, 29 and which converts the reference level of the input signal Φ, and a charge transfer circuit which is composed of the transistors 31, 34, and 35 and which transfers the load from the node 26 to the node 32 so as to prevent backflow of the load from the node 32 to the node 26. In the voltage generation circuit shown in FIG. 3, n charge transfer circuits are connected in series to supply the charge transfer circuit in the next stage with a voltage which is V_{DD} lower than the charge transfer circuit in the preceding stage, thereby generating a negative voltage which is n times the magnitude of the voltage V_{DD}.

In the voltage generation circuit of the present embodiment shown in FIG. 8, a voltage changing between a voltage −V_{DD} and the ground voltage is inputted (through the node 26) and a voltage −V_{DD} is outputted (through the node 32) in the charge transfer circuit in the first stage. The node 32 is supplied with a repetitive signal /Φ (or Φ) via the capacitor 33. In result, the node 32 changes between a voltage −2V_{DD} and a voltage −V_{DD}. The voltage of the node 32 is inputted to the charge transfer circuit in the second stage, and the charge transfer circuit in the second stage outputs a voltage −2V_{DD} to the node 32a.

In the charge transfer circuit in the first stage, the source electrode of the transistor 34 is grounded. In contrast, the transistor 34a of the charge transfer circuit in the second stage must be supplied with a voltage −V_{DD}. Therefore, the charge transfer circuit in the first stage is provided with the transistor 37 and the voltage stabilization capacitor 38. The transistor 37 and the capacitor 38 operate in the same manner as the transistor 31 and the capacitor 33 in FIG. 3 (Embodiment 3), and generate a voltage −V_{DD} in the node 39, that is, the source electrode of the transistor 34a.

According to the present embodiment, in the voltage generation circuit shown in FIG. 3, connecting the charge transfer circuits in series in plural stages makes it possible to input a voltage which is V_{DD} lower than each input of the charge transfer circuit in the preceding stage to the charge transfer circuit in the next stage with simple circuit configuration. This enables easy obtaining of a negative voltage which is an integral multiple of the power supply voltage, such as −2V_{DD}, −3V_{DD}, - - - , −n·V_{DD}.

Embodiment 9

In the voltage generation circuit shown in FIG. 8, the node 32n in the final stage out of the nodes 32, 32a, - - - , 32n serves as the output; however, it is possible to use the nodes 39, 39a, - - - as the output. For example, it is possible to take out a voltage −V_{DD} from the node 39 and a voltage −2V_{DD} from the node 39a.

According to the present embodiment, it is possible to output an intermediate voltage besides the output voltage in the final stage. This can eliminate the need for the provision of plural voltage generation circuits, even when different voltages are necessary, which is advantageous in terms of cost, space, and reliability.

### Embodiment 10

In the voltage generation circuit of Embodiment 9 where the intermediate voltage is outputted from the nodes 39, 39a, - - - , there are such cases that a large amount of current flows to the load and fluctuate the output voltage, that is, the voltage of the nodes 39, 39a, - - - .

In such a case, as shown in FIG. 19, it is possible to provide a transistor 37′ and a voltage stabilization capacitor 38′ in parallel to the transistor 37 and the voltage stabilization capacitor 38, and to connect the load 40 to the node 39′.

Even when the output voltages of the nodes 39′, 39a′, - - - are decreased by the load current “i”, the output voltages of the nodes 39, 39a, - - - are hardly affected. This can secure the operation of the voltage transfer circuit (transistors 31a, 31b, - - - ), without a fluctuation in the voltages to be supplied to the transistors 34a, 34b, - - - in the next stage.

### INDUSTRIAL APPLICABILITY

The voltage generation circuit of the present invention can provide an output voltage which is not affected by the threshold voltages of the transistors. Consequently, even when there is a wide range of variation in the threshold voltages of the transistors, it is possible to output a necessary voltage without fail, thereby enhancing the operation reliability of the device using the voltage generation circuit of the present invention.

The voltage generation circuit of the present invention can prevent backflow of electric charge (negative charge) from the output node (terminal) to the input node (terminal), thereby providing an output voltage efficiently.

In the voltage generation circuit of the present invention, the minimum set of voltage signals is a repetitive signal for charge pump operation and a constant-voltage signal for providing a reference voltage, and there is no need for the provision of a control signal.

The voltage generation circuit of the present invention can output a high voltage with ease by connecting plural charge transfer means in series in plural stages. Furthermore, an intermediate voltage can be obtained from the charge transfer means in the immediate stage.

1. A voltage generation circuit in which an alternating voltage is inputted through an input node and a constant voltage is outputted through an output node, wherein charge transfer means, which is provided between the input node and the output node, is so controlled by the alternating voltage of the input node that an amount of electric charge flowing from the input node to the output node is different from an amount of electric charge flowing from the output node to the input node, to form a rectifier which causes no voltage drop in the forward direction.

2. A voltage generation circuit in which a constant voltage is outputted through an output node, comprising: a first input node to which an alternating voltage is inputted; a second input node to which a constant reference voltage is inputted; a first switching element which is connected between the first input node and an output node; a second switching element which is connected between the second input node and a control terminal of the first switching element; and a third switching element which is connected between the control terminal of the first switching element and the output node.

3. A voltage generation circuit in which a constant voltage and an alternating voltage signal is supplied to an input terminal, and a constant voltage is outputted through an output terminal, comprising: voltage level conversion means for converting the reference level of the alternating voltage signal and outputting a converted reference level to an intermediate node; and charge transfer means which is provided between the intermediate node and the output terminal, and which is so controlled by the voltage signal of the intermediate node that an amount of electric charge flowing from the intermediate node to the output terminal is different from an amount of electric charge flowing from the output terminal to the intermediate node to form a rectifier which causes no voltage drop in the forward direction.

4. The voltage generation circuit of claim 3, wherein the charge transfer means comprises: a first switching element which is connected between the intermediate node and the output terminal; a second switching element which is connected between the input terminal having a constant voltage and the control terminal of the first switching element; and a third switching element which is connected between the control terminal of the first switching element and the output terminal.

5. The voltage generation circuit of claim 3, wherein the voltage level conversion means comprises: a fourth switching element which is disposed between the input terminal having a constant voltage and the intermediate node; a first capacitor which is disposed between the intermediate node and the input terminal of the alternating voltage signal; and reverse phase signal supply means which supplies a control terminal of the fourth switching element with a signal having a substantially reverse phase against the alternating voltage signal.

6. The voltage generation circuit of claim 5, wherein the reverse phase signal supply means comprises: a reverse phase signal input terminal which is supplied with an alternating signal having a substantially reverse phase against the alternating voltage signal; a second capacitor which is disposed between the reverse phase signal input terminal and the control terminal of the fourth switching element; and a fifth switching element which is disposed between the input terminal having the constant voltage and the control terminal of the fourth switching element, and which is controlled by the voltage signal of the intermediate node.

7. The voltage generation circuit of any one of claims 2 to 4, wherein the first switching element is a P-type field-effect transistor, the second switching element is an N-type field-effect transistor, and the third switching element is a P-type field-effect transistor.

8. The voltage generation circuit of any one of claims 2 to 4, wherein the first switching element is an N-type field-effect transistor, the second switching element is a P-type field-effect transistor, and the third switching element is an N-type field-effect transistor.

9. The voltage generation circuit of any one of claims 5 to 6, wherein the fourth switching element is an N-type field-effect transistor.

10. The voltage generation circuit of any one of claims 5 to 6, wherein the fourth switching element is a P-type field-effect transistor.

11. The voltage generation circuit of claim 9, wherein the fifth switching element is an N-type field-effect transistor.

12. The voltage generation circuit of claim 10, wherein the fifth switching element is a P-type field-effect transistor.

13. The voltage generation circuit of claim 6, wherein the control terminal of the first switching element and the reverse phase signal input terminal are connected via a third capacitor.

14. The voltage generation circuit of claim 3, wherein the constant voltage supplied is a positive voltage.

15. The voltage generation circuit of claim 14, wherein the output voltage of the output terminal is the sum of the positive voltage and the peak-to-peak voltage amplitude of the alternating voltage signal.

16. The voltage generation circuit of claim 3, wherein the constant voltage supplied is a ground potential.

17. The voltage generation circuit of claim 16, wherein the output voltage of the output terminal is a difference between the ground potential and the peak-to-peak voltage amplitude of the alternating voltage signal.

18. The voltage generation circuit of claim 3 further comprising a voltage stabilization capacitor disposed between the output terminal and the voltage source having a constant voltage.

19. A voltage generation circuit having charge transfer means connected in series in plural stages, each of the charge transfer means comprising: an input node to which an alternating voltage signal is inputted; an input terminal to which a reference voltage is inputted; a first and a second output node which output a constant voltage; a first switching element which is connected between the input node and the first output node; an additional switching element which is connected between the input node and the second output node; a connection node which is connected between the control terminal of the first switching element and the control terminal of the additional switching element; a second switching element which is connected between the reference voltage input terminal and the connection node; and a third switching element which is connected between the connection node and the first output node,
wherein the first output node of the charge transfer means in the preceding stage is connected with the alternating voltage signal via a capacitor, and also with the input node of the charge transfer means in the next stage, whereas the second output node of the charge transfer means in the preceding stage is connected with the reference voltage input terminal of the charge transfer means in the next stage.

20. The voltage generation circuit of claim 19, wherein an output voltage is outputted from the charge transfer means in the final stage and an intermediate voltage is taken out from the second output node of the charge transfer means in the intermediate stage.

21. The voltage generation circuit of claim 19, wherein the charge transfer means is provided with a third output node, and an additional switching element which is connected between the input node and the third output node and a control electrode of which is connected to the connection node, and wherein an output voltage is outputted from the charge transfer means in the final stage, and an intermediate voltage is taken out from the third output node of the charge transfer means in the intermediate stage.

22. The voltage generation circuit of claim 19, wherein a positive voltage is inputted to the reference voltage input terminal of the charge transfer means in the first stage, and the charge transfer means in the next stage outputs a voltage higher than the output of the charge transfer means in the preceding stage by the peak-to-peak voltage amplitude of the alternating voltage signal.

23. The voltage generation circuit of claim 19, wherein the reference voltage input terminal of the charge transfer means in the first stage is connected to the ground potential, and the charge transfer means in the next stage outputs a voltage lower than the output of the charge transfer means in the preceding stage by the peak-to-peak voltage amplitude of the alternating voltage signal.
